(19) United States
(12) Patent Application Publication
(10) Pub. No.: US 2019/0028641 A1
(43) Pub. Date: Jan. 24, 2019

(54) SYSTEMS AND METHODS FOR HIGH RESOLUTION IMAGING USING A BUNDLE OF OPTICAL FIBERS

(71) Applicants: Université d'Aix-Marseille, Marseille (FR); CENTRE NATIONAL DE LA RECHERCHE SCIENTIFIQUE - CNRS, Paris (FR); Ecole Centrale de Marseille (ECM), Marseille (FR); Weizmann Institute of Science (WIS), Rehovot (IL)

(72) Inventors: Hervé Rigneault, Allauch (FR); Esben Andresen, Marseille (FR); Amir Porat, Kfar-Saba (IL); Dan Oron, Rehovot (IL); Ori Katz, Moshav Bazra (IL); Sylvain Gigan, Paris (FR)

(73) Assignees: Université d'Aix-Marseille, Marseille (FR); CENTRE NATIONAL DE LA RECHERCHE SCIENTIFIQUE - CNR S, Paris (FR); Ecole Centrale de Marseille (ECM), Marseille (FR); Weizmann Institute of Science (WIS), Rehovot (IL)

(21) Appl. No.: 16/063,139

(22) PCT Filed: Dec. 17, 2015
(86) PCT No.: PCT/IB2015/002585

§ 371 Date: Jun. 15, 2018

(51) Int. Cl. H04N 5/232; G02B 6/06; G02B 27/14; G02B 27/48

(52) U.S. Cl. CPC H04N 5/23232; G02B 6/06; H04N 2005/2255; G02B 27/48; G02B 27/141

(57) ABSTRACT

According to one aspect, the present description relates to a system for high resolution imaging of an object comprising a fiber bundle (1) comprising an array of optical fiber cores (A), said fiber bundle being adapted to receive a plurality of light beams issued from spatially incoherent point sources of an object; the system further comprises a two-dimensional detector (240) with a detection plane, located at a proximal end of the fiber bundle, adapted to receive speckle patterns, each speckle pattern resulting from the transmission of one of said light beams through at least a plurality of the fiber bundle cores, the ensemble of speckle patterns detected by the two-dimensional detector forming a multiple speckles image; and a processing unit (250) adapted to determine an image of the object from said multiple speckles image.

### PRIOR ART

### Technical Field

The present description relates to systems and methods for high resolution imaging using a bundle of optical fibers. It is applicable but not limited to endoscopic imaging.

### Prior Art

Flexible optical endoscopes are one of the most important tools in biomedical investigation and clinical diagnostics. They enable imaging deep inside complex samples, at depths where scattering prevents conventional noninvasive microscopic investigation. An ideal micro endoscopic probe should allow real time, diffraction-limited imaging at various axial distances from its facet (distal end), together with the smallest possible cross-sectional footprint to minimize tissue damage.

Recently, there has been a surge of works employing wavefront-shaping for lens less micro endoscopy through single multimode fibers. In the published Patent Application US 2015/0015879 for example, a multimode waveguide illuminator and imager is shown, relying on a wave-front shaping system that acts to compensate for modal scrambling and light dispersion by the multimode waveguide. However, the main hurdle in applying wavefront-shaping based correction in practical endoscopic scenarios is the sensitivity of the wavefront distortion to any bending of the fiber, requiring either access to the distal end for recalibration of the wavefront correction, or precise knowledge of the bent shape for computational wavefront compensation.

A more conventional and widely-used type of optical endoscopes is based on fiber bundles, which are constructed from thousands of individual optical fiber cores packed together, each of the cores carrying one image pixel information.

Imaging with various modalities is performed in a straightforward manner when the target object is positioned immediately adjacent to the bundle's facet, or equivalently at the focal plane of a miniature objective lens attached to the fiber's distal end. FIG. 1A, FIG. 1B and FIG. 1C respectively show an arrangement of optical fiber cores 1_{A} in a fiber bundle 1, the formation of an image 3 of a target object 2 positioned adjacent to a fiber bundle's distal facet 11 and an example of an image 5_{A} of a portion 4_{A} of a test chart 4 obtained using this method. In such conventional fiber bundle imaging, the intensity image of the object 2 placed adjacent to the fiber bundle's distal facet 11 is transferred to the fiber bundle's proximal facet 12. While straightforward to implement, such fiber bundle based techniques suffer from limited resolution and pixilation artifacts dictated by the individual cores and cladding diameters, and from fixed working distance which, without the addition of micro fabricated lenses, locates the target object directly at the bundle's surface.

The present invention provides wide field, pixilation-free imaging methods and systems, capable of imaging at arbitrary distance using nothing but a bare conventional fiber bundle and a camera, and requiring no distal optics.

### SUMMARY

According to a first aspect, the present description relates to a system for high resolution imaging of an object comprising:
a fiber bundle comprising an array of optical fiber cores, said fiber bundle being adapted to receive a plurality of light beams issued from spatially incoherent point sources of an object;
a two-dimensional detector located at a proximal end of the fiber bundle, adapted to receive speckle patterns, each speckle pattern resulting from the transmission of one of said light beams through at least a plurality of the fiber bundle cores, the ensemble of speckle patterns detected by the two-dimensional detector forming a multiple speckles image; and
a processing unit adapted to determine an image of the object from said multiple speckles image.

The inherent variations in refractive indices and geometries between the cores in a fiber bundle result in unpredictable fiber to fiber phase delay of the light passing through them. Conventional bundle imaging approaches—as shown in FIG. 1B—work under the assumption that phase information is lost upon propagation through the bundle, and thus rely on intensity-only information transmittance through it. In multimode waveguide imaging methods (see for example US 2015/0015879 cited above), these phase relations are measured and compensated using a spatial light modulator.

Despite these seemingly fundamental restrictions, the inventors have shown that some phase information is retained in propagation through a conventional fiber bundle. More precisely, the inventors have shown the existence of inherent angular and spectral correlations of speckle patterns generated by propagation of light beams issued from spatially incoherent point sources of an object through a fiber bundle.

Systems and methods of the present description exploit the correlations of the speckle patterns to image objects placed at any arbitrary distance from the bundle distal end, without any phase correction or pre-calibration.

According to one or more embodiments, the system for high resolution imaging of an object comprises a light source to illuminate the object.

According to one or more embodiments, the light source is a spatially incoherent light source and illuminates the object in reflection or in transmission.

According to one or more embodiments, the light source is adapted to emit a light at a first wavelength (the excitation wavelength), which results in a light emission by the object at a second wavelength (the emission wavelength) different from the excitation wavelength. The light emitted by the object may be for example fluorescence light, or Raman light, which is naturally spatially incoherent.

According to one or more embodiments, the processing unit is adapted to perform:
an autocorrelation product of the multiple speckles image;
a determination of the image of the object based on the autocorrelation product of the multiple speckles image.

According to one or more embodiments, the determination of the image of the object based on the autocorrelation product of the multiple speckles image is made using a phase retrieval algorithm.

According to one or more embodiments, the system for high resolution imaging further comprises a lens at the distal end of the fiber bundle to shorten a minimal distance at which an object may be imaged with an optimized signal to noise ratio.

According to one or more embodiments, the system for high resolution imaging further comprises:
a reference arm of variable length;
a beam splitter to split a spatially incoherent light emitted by a source into a light for illuminating the object and a light to be sent into the reference arm;
a beam splitter to mix the light from the reference arm and the light back reflected by the object and transmitted by the at least part of the cores of the fiber bundle at the detection plane.

According to a second aspect, the present description relates to a method for high resolution imaging of an object comprising:
receiving at the distal end of a fiber bundle comprising an array of optical fiber cores a plurality of light beams issued from spatially incoherent point sources of an object;
receiving using a two-dimensional detector located at a proximal end of the fiber bundle, a plurality of speckle patterns, each speckle pattern resulting from the transmission of one of said light beams through at least a plurality of the fiber bundle cores, the ensemble of speckle patterns detected by the two-dimensional detector forming a multiple speckles image;
processing said multiple speckles image to determine an image of the object.

According to one or more embodiments, the method further comprising illuminating the object, using a spatially incoherent light, the object being illuminated in reflection, or in transmission.

According to one or more embodiments, illuminating the object is made through at least part of the optical fiber cores of the fiber bundle.

According to one or more embodiments, the light for illuminating the object has a narrow spectral bandwidth, i.e. a spectral bandwidth smaller or equal than the spectral correlation width of the fiber bundle, typically smaller than a few tens of nm, advantageously smaller than or equal to 10 nm, advantageously smaller than or equal to 5 nm.

According to one or more embodiments, the method further comprising illuminating the object, using a light at a first wavelength (the excitation wavelength), and the object emits light at a second wavelength (the emission wavelength) different from the excitation wavelength, to form said plurality of light beams. The light emitted by the object may be for example fluorescence light, or Raman light, which is naturally spatially incoherent, thus the excitation light doesn't need to be spatially incoherent.

According to one or more embodiments, processing the multiple speckles image comprises:
calculating an autocorrelation product of the multiple speckles image;
determining the image of the object based on the autocorrelation product of the multiple speckles image.

According to one or more embodiments, determining the image of the object based on the autocorrelation product of the multiple speckles image is made using a phase retrieval algorithm.

According to one or more embodiments, the method further comprises randomly moving the fiber bundle at the proximal end to increase the number of speckle patterns.

According to one or more embodiments, the method further comprises randomly changing the wavelength of a light illuminating the object to increase the number of speckle patterns.

According to one or more embodiments, the method further comprises randomly changing the polarization state of a light illuminating the object to increase the number of speckle patterns.

According to one or more embodiments, the method further comprises determining the distance between the object and the fiber bundle's distal facet by:
Splitting a spatially incoherent light into a light for illuminating the object and a light to be sent in a reference arm of a variable length;
Mixing at the detector plane the light from the reference arm and the light back reflected from the object and transmitted by the at least part of the cores;
Changing the length of the reference arm to generate interference fringes at the detector plane.

According to further aspects, the present description relates to apparatuses including systems for high resolution imaging, wherein said apparatuses comprise endoscopic apparatuses for life science, remote imaging apparatuses for applications other than life science, remote spectroscopy apparatuses, etc.

### BRIEF DESCRIPTION OF THE DRAWINGS

Other advantages and features of the invention will become apparent on reading the description, which is illustrated by the following figures:

FIGS. 1A, 1B and 1C (already described), an arrangement of optical fiber cores in a fiber bundle, forming an image of a target object positioned adjacent to a fiber bundle's facet and an example of an image of a portion of a test chart;

FIG. 2, schematic of a system for high resolution imaging using a bundle of optical fibers, according to an embodiment of the present description;

FIGS. 3A and 3B, a schematic illustration of two tilted wave fronts issued from two spatially incoherent point sources and propagating through a fiber bundle and experimental measurements showing the angular speckle correlation of the fiber bundle as a function of the position of the point source δX.

FIGS. 4A and 4B, a schematic illustration of the different steps in an embodiment of method for high resolution imaging according to an embodiment of the present description and an example of a multiple speckles image (numerical simulation);

FIG. 5, a schematic illustration of an experimental set-up used to demonstrate the feasibility of the method for high resolution imaging according to an embodiment of the present description;

FIG. 6, illustrations of the facet image when the object is positioned adjacent to a fiber bundle's distal facet and far from the bundle's distal facet;

FIGS. 7A to 7I, images at the different steps of the method implemented using the set-up of FIG. 5, for different objects (“4”, “3” and “6”);

FIGS. 8A to 8H, a curve (experimental) showing the image resolution and images (experimental) obtained at different distances of the object from a fiber bundle's facet using the set-up of FIG. 5;

FIGS. 9A to 9D, images (experimental) showing the original object and the measured object using a single shot and a 20 shots measurements, and a curve (experimental) showing the spectral correlation of a bundle as a function of the relative wavelength, with a imaging method implemented using the set-up of FIG. 5, for the same object (“5”);

FIG. 10, a schematic illustration of another embodiment of a device according to the present description;

FIG. 11, a schematic illustration of another embodiment of a device according to the present description.

### DETAILED DESCRIPTION

In the figures, identical elements are indicated by the same references.

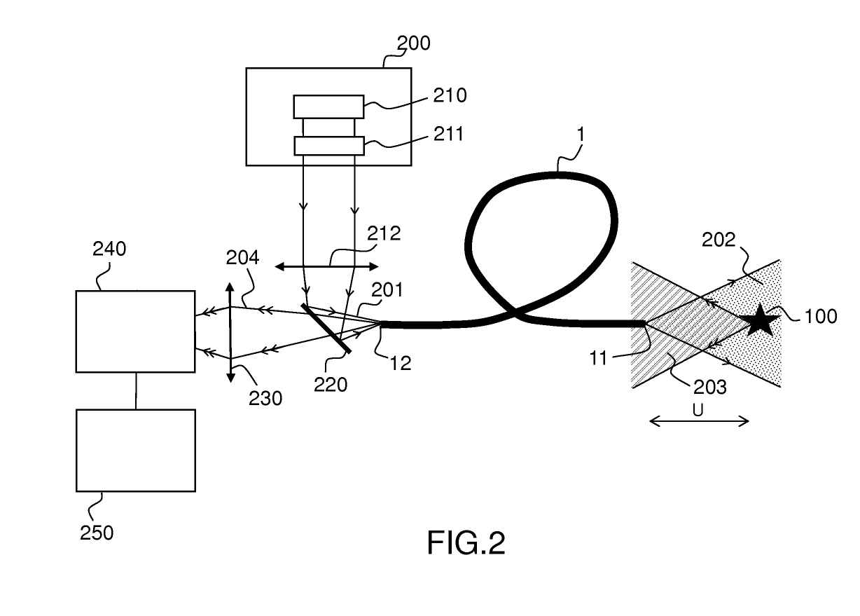

FIG. 2 shows an example of a system for high resolution imaging of an object, according to a first embodiment of the description.

The system as shown in FIG. 2 may be applied to endoscopic imaging or any remote imaging where a fiber bundle is advantageously used between the object and the detector.

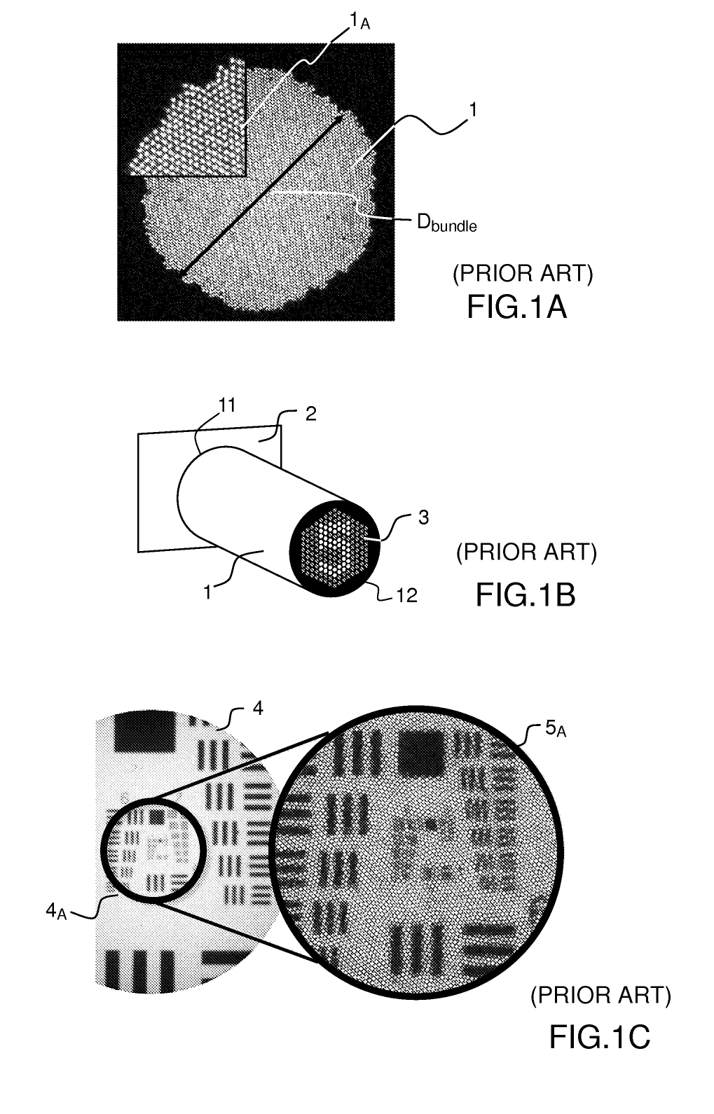

The system for high resolution imaging comprises a fiber bundle 1 of length L. The fiber bundle may be a fiber bundle as shown in FIG. 1A, and comprises an array of optical fiber cores 1_{A}. The system for high resolution imaging further comprises, at a proximal end of the fiber bundle, a two-dimensional detector 240 and a processing unit 250. The two-dimensional detector 240 is placed a non-zero distance from the fiber bundle's proximal facet.

The system for high resolution imaging may further comprise a source 200 for illuminating the object 100 in applications where objects are not self emitting, e.g. objects pressing chemiluminescence.

In the example of FIG. 2, the source 200 is located at a proximal end of the fiber bundle 1, enabling to illuminate the object in reflection. However, in some applications, the object may be illuminated in transmission.

In one or more embodiments, reflected light by the object (or transmitted light through the object) directly form a plurality of light beams issued from point sources of said object that will be transmitted through all or part of the cores of the fiber bundle (the “transmission cores”). To ensure that said point sources are spatially incoherent point sources, the light issued by the source 200 may be spatially incoherent light.

In one or more embodiments, the source emits light at a first wavelength (the excitation wavelength) to illuminate the object, resulting in an emission by each point source of the object of a light at a second wavelength (the emission wavelength) different from the excitation wavelength. For example, emission light may be fluorescence light, Raman light, Doppler shifted light, etc. In case of fluorescence light and Raman light for example, the light is naturally spatially incoherent and the excitation light doesn't need to be spatially incoherent.

In one or more embodiments, the light transmitted through the cores of the fiber bundle has a wavelength adapted to the nature of the fiber bundle, i.e. a wavelength at which light is transmitted by the cores of the fiber bundle, and more preferably, light for which the coupling between the cores is minimized, although it is not necessarily zero. Such wavelength depends on the fiber bundle used in the specific application; however, fiber bundles used in imaging applications may usually transmit light having wavelengths comprised between 350 nm and 3 μm.

In to one or more embodiments, light emitted by the source 200 has a given central wavelength and a narrow bandwidth, i.e. a bandwidth smaller or equal than the spectral correlation width of the fiber bundle at said emission wavelength, as it is explained in further details below. Typically, for fiber bundles that are generally used in optical imaging applications, the spectral bandwidth of the source may be smaller than few tens of nm, for example smaller than or equal to 10 nm, in some further embodiments smaller than or equal to 5 nm.

In to one or more embodiments, light emitted by the source has a spectral bandwidth larger than the spectral correlation width of the fiber bundle and a spectral filter may be arranged at a proximal end of the fiber bundle, before the two-dimensional detector 240, to limit the spectral bandwidth of the detected light at a value smaller or equal than the spectral correlation width of the fiber bundle.

In one or more embodiments, the light emitted by the source is a continuous wave light or a pulsed light.

In one or more embodiments, the source may comprise thermal lamps, LEDs, spatially incoherent super continuum sources, spatially incoherent solitons light sources, spatially incoherent laser light sources, etc.

In the example of FIG. 2, light 201 emitted from the source 200 is sent into at least part of the cores of the fiber bundle 1 (“illumination cores”), directly or using an objective 212. In further embodiments, light 201 emitted from the source 200 may be sent to one or a plurality of cores of optical fibers that are not part of the fiber bundle 1 but are specifically used for the illumination of the object (100).

The light 202 transmitted through the illumination cores illuminates an object 100 located at a distal end of the fiber bundle at a non-zero distance U of the fiber bundle's distal facet 11 (“the object plane”). Light 203 emitted by the object in return, e.g. reflected light, transmitted light, fluorescence light, Raman light, form a plurality of light beams issued from spatially incoherent point sources of the object that illuminates the cores of the fiber bundle 1.

In one or more embodiments, the object is positioned further than a given distance of the fiber bundle distal facet 11 and light beams illuminating the cores of the fiber bundle are transmitted through all the cores of the bundle.

In one or more embodiments, when the object is positioned closer to the fiber bundle distal facet 11 at least part of the cores may not transmit the light beams emitted by some of the point sources of the object, depending on the numerical aperture of the cores.

In the following, we define the “transmission cores” as the ensemble of the cores of the fiber bundle which all transmit the light beams emitted by the same point sources of the object. In the case where said ensemble of the cores doesn't comprise all the cores of the fiber bundle, it may be advantageous to limit physically, e.g. using a mask, the ensemble of the cores to be used as the transmission cores, to ensure that all transmission cores will emit the light beams issued from the same point sources of the object.

The effective diameter of the fiber bundle is defined in this case as the maximal distance between two transmission cores.

As it will be further explained, the effective diameter of the bundle and the number of transmission cores may be chosen big enough to ensure sufficient sensitivity and resolution of the imaging method.

As it will be further explained, it may also be possible to define a minimal distance (the critical distance) between the object and the fiber bundle's distal facet above which an object may be imaged with an optimized signal to noise ratio.

As shown in FIG. 2, the light 204 transmitted through said plurality of transmission cores is captured by the two-dimensional detector 240, e.g. a CCD, or a CMOS camera, and processed by the processing unit 250.

The camera 240 is placed at a non-zero distance from the bundle's proximal facet 12 (“the image plane”), or behind an objective 230; said objective doesn't image the bundle's proximal facet on the detector but enables to direct the light 204 emitted from the fiber bundle onto the camera.

In the arrangement of FIG. 2, a beam splitter 220 is used to separate the emission light 201 and the transmitted light 204 at the proximal end of the fiber bundle 1. For example, as shown In FIG. 2, the beam splitter reflects the emission light 201 into the illumination cores and transmits the transmitted light toward the camera 240. However, in another embodiment, the beam splitter may transmit the emission light 201 into the illumination cores and reflect the transmitted light toward the camera 240.

According to one or more embodiments, the beam splitter 220 may be a dichroic plate, e.g. when the emission light 201 and the transmitted light 204 have different wavelengths.

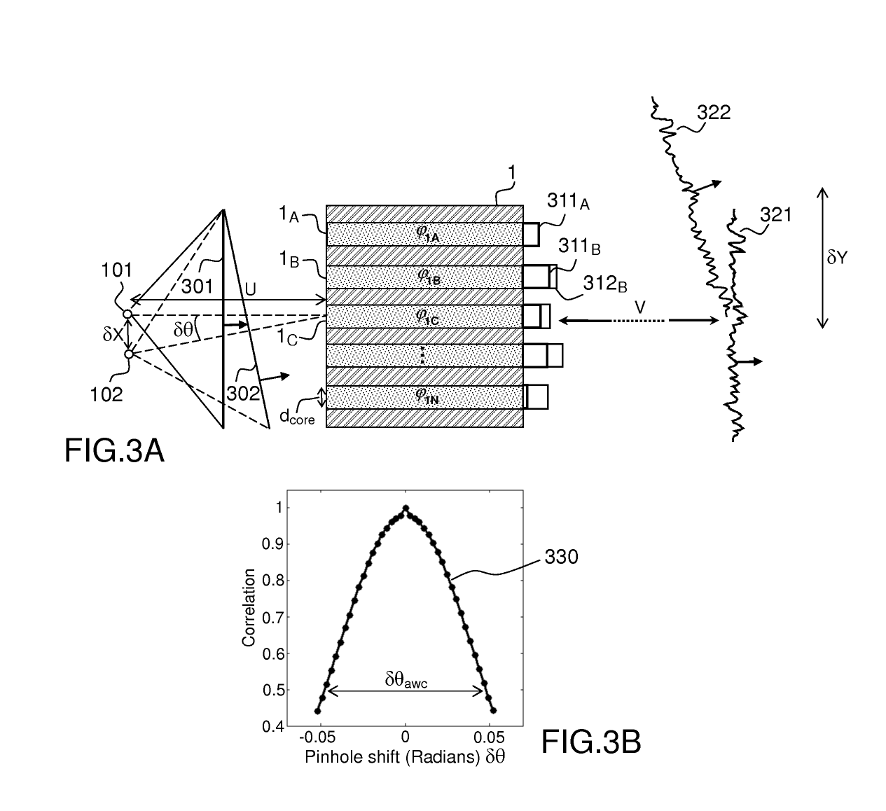

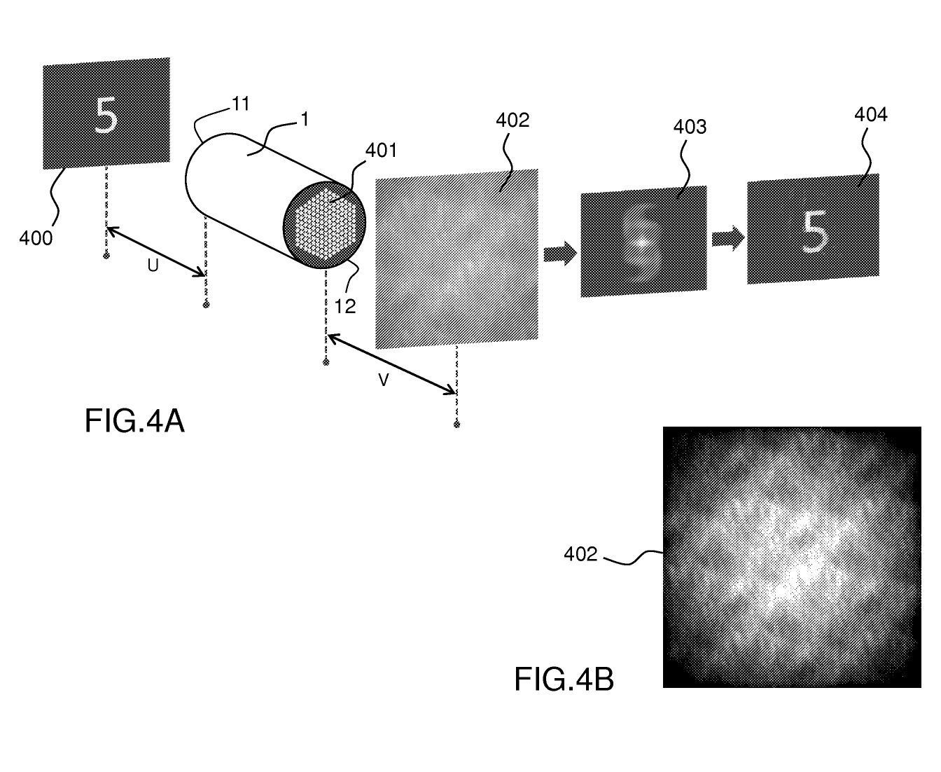

The principle of the method for high resolution imaging according to an embodiment is now described with reference to FIGS. 3A, 3B and 4A, 4B.

As shown in FIG. 3A, the propagation of light through an imaging fiber bundle 1 is characterized by the fact that each core in the bundle, referenced 1ᵢ, conserves the intensity of the light that is coupled to it, but adds to its phase an unknown phase, φ1ᵢ, which varies from core to core. Such unknown phase φ1ᵢ, may depend from the composition of each individual core, its length or the bending of the fiber bundle. Thus, a point source 101 that is placed in an object plane at a distance U from the bundle distal facet, and emits a spherical wavefront 301 illuminating the cores of the fiber bundle 1, will produce a random speckle pattern 321 in an image plane at a distance V from the bundle proximal facet 12, due to the added random phase pattern to the otherwise spherical wavefront. Since the added random phases φ1ᵢ are independent of the position of the point source, a second point source 102 placed at the object plane, but shifted in transverse position by a distance δX relative to the first point source and emitting a spherical wavefront 302 will produce a nearly identical speckle pattern 322 at the image plane, but shifted by ∂Y=V/U∂X. Indeed, at the output of each core 1ᵢ, the local wavefront 312ᵢ resulting from the transmission of the wavefront 302 emitted by the point source 102 through the core 1ᵢ differs from the local wavefront 311ᵢ resulting from the transmission of the wavefront 301 emitted by the point source 101 through the same core 1ᵢ by a linear ramp (tilt).

The applicants have shown that within a given angular range, and within a given spectral bandwidth, two point sources produce highly correlated, but shifted by

$$\partial Y = \frac{V}{U} \partial X ,$$

speckle patterns. The fiber bundle can thus be considered as an optical system having a complex, yet shift invariant, point spread function (PSF), which is exactly this speckle pattern. Therefore, analyzing the resulting speckle intensity pattern at the image plane when the two sources are present can directly yield the relative position of the sources.

FIG. 3B shows angular correlation measurements between two speckle patterns as a function of a pinhole shift δθ measured in Radians, with respect to the location of the point source at 0 rad. The pinhole shift is directly related to the distance δX (FIG. 3A) between two point sources by the formula:

$$\partial θ = \frac{\partial X}{U}$$

The measurements shown in FIG. 3B were obtained by illuminating a pinhole from its back using a narrow bandwidth (typically smaller than 20 nm) spatially incoherent source emitting at λ=532 nm. The diameter dₚᵢₙₕₒₗₑ of the pinhole used for the measurements is smaller than that which can be resolved by the fiber's aperture, i.e.

$${D}_{bundle} < \frac{λ}{{d}_{pinhole}} U ,$$

wherein λ is the central wavelength of the source and D_{bundle} is the diameter of the bundle measured by the maximal distance between two cores. The fiber bundle used for these experiments has a length of 105 cm, and a diameter D_{bundle}=0.53 mm, about 4500 cores are present with a 7.5 μm inter-core distance.

The applicants have demonstrated theoretically that for an ideal fiber bundle, with randomly positioned single-mode cores and no core-to-core coupling, the fiber bundle's angular correlation width δθ_{awe} is essentially the core's numerical aperture (NA), i.e.

$$δ {θ}_{awc} = NA = \frac{λ}{{d}_{mode}} \approx \frac{λ}{{d}_{core}} \qquad ( 1 )$$

where d_{mode} is the diameter of a mode of a core which can be approximated to the diameter dₒᵣₑ of the core itself in the case of a single mode fiber.

The theoretical conclusion is experimentally verified with the experiments shown in FIG. 3B. The theoretical value of the fiber bundle's angular correlation width δθ_{awe} is about 0.07 according to the commercial specifications of the fiber bundle. As shown, a fit 330 to a normal distribution of the experimental points shown in FIG. 3B gives the same order of magnitude for the FWHM (full width half maximum), i.e. FWHM ˜0.09.

As a direct result of the conclusion above, when a spatially-incoherently illuminated object 400 (see FIG. 4A) is placed at a sufficiently large distance U from the fiber bundle's distal facet 11, the light from every point on the object will form correlated but shifted speckle patterns at a sufficient distance V from the fiber bundle's proximal facet 12. The resulting light intensity 402 (also shown in FIG. 4B) at this image plane, referred to in the present description as the “multiple speckles image” will be the incoherent intensity sum of the superimposed shifted speckle patterns.

It results that within the angular and spectral correlation widths, one can describe the light intensity measured in the far field of the fiber bundle's proximal facet by a simple convolution between the object's intensity pattern O(r), and the single (unknown) speckle pattern PSF(r):

I(r)=O(r)*PSF(r) (2)

According to one or more embodiments, the image of the object can be reconstructed from the autocorrelation of this multiple speckles image, as it is known in the art—See Labeyrie et al. (“Attainment of diffraction limited resolution in large telescopes by Fourier analyzing speckle patterns in star images”, Astronomy and Astrophysics, 6:85, 1970.).

Taking the autocorrelation (marked by ⊗) of this intensity image I(r) gives:

I(r)⊗I(r)=(O(r)⊗O(r))*(PSF(r)⊗PSF(r)) (3)

Since the autocorrelation of a random speckle pattern PSF(r)⊗PSF(r) is a sharply-peaked function having a peak with a width of a diffraction limited spot, one can see that the autocorrelation of the output intensity will approximate the autocorrelation of the object itself (up to a statistical average over the number of captured speckle grains and a constant background term).

Thus, the autocorrelation (403, FIG. 4A) of a single camera image of the light propagated through the fiber bundle, I(r)⊗I(r) is essentially identical to the target object's autocorrelation, and one can directly reconstruct the original object 404 from this auto correlation.

Determination of the image of the object may be done using for example a known phase retrieval algorithm, as it is described for example in Fienup, J. R. et al. (“Phase retrieval algorithms: a comparison.” Applied Optics, 21:2758{2769, 1982).

It is also possible to determine the image of the object—from the autocorrelation product of the multiple speckles image—by comparing the autocorrelation of the object using a database of object autocorrelation pair.

Note that other algorithms beyond autocorrelation and phase retrieval can also be used to retrieve the image of the object directly from the multi speckles image, as described for example in J. C. Dainty (“Laser speckle and related phenomena”, Springer, Topics in applied physics, Vol. 9 1975, ISBN: 978-3-540-07498-4) Such algorithms include bispectrum analysis, Knox-Thompson algorithm and speckle holography.

The high resolution imaging explained above was experimentally tested using the experimental set-up of FIG. 5.

In the experimental set-up of FIG. 5 a target object 400 is illuminated by a spatially incoherent narrowband source 500 and placed at various distances from a 530 μm diameter, 105 cm long, fiber bundle 1, having 4500 cores and an inter-core distance of 7.5 μm. The light source 500 is a pseudo-thermal spatially-incoherent source, composed of a Coherent Compass 215M-50 532 nm CW laser, whose beam is expanded approximately ×50 times by a telescope 502, passed through a focusing lens 503 and then through a rapidly rotating diffuser 504. The light that passed through the object 400 is collected by the fiber bundle 1, and imaged by the camera 540 after forming a speckle pattern, with or without an imaging objective 530. The camera used is a Pco.edge® 5.5 (2,560×2,160 pixels) with an integration time varied between 10 milliseconds to 2 seconds (typically a few hundred milliseconds).

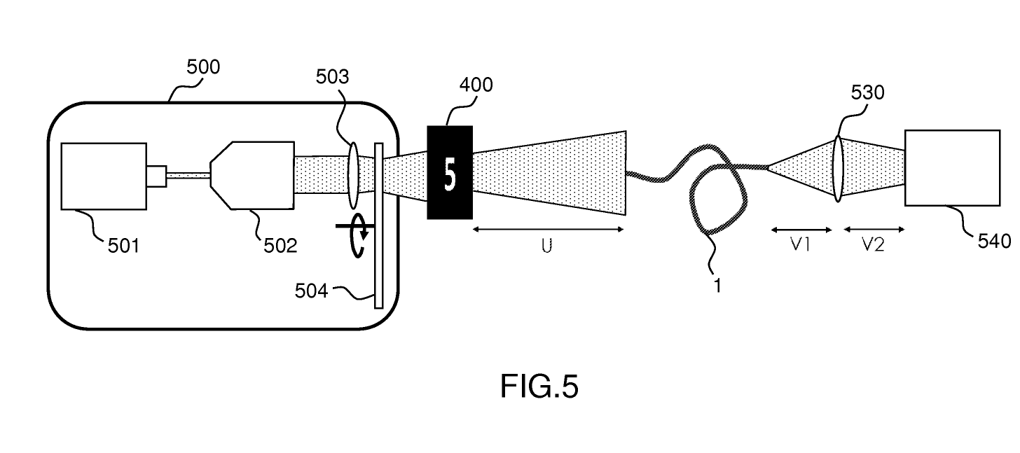

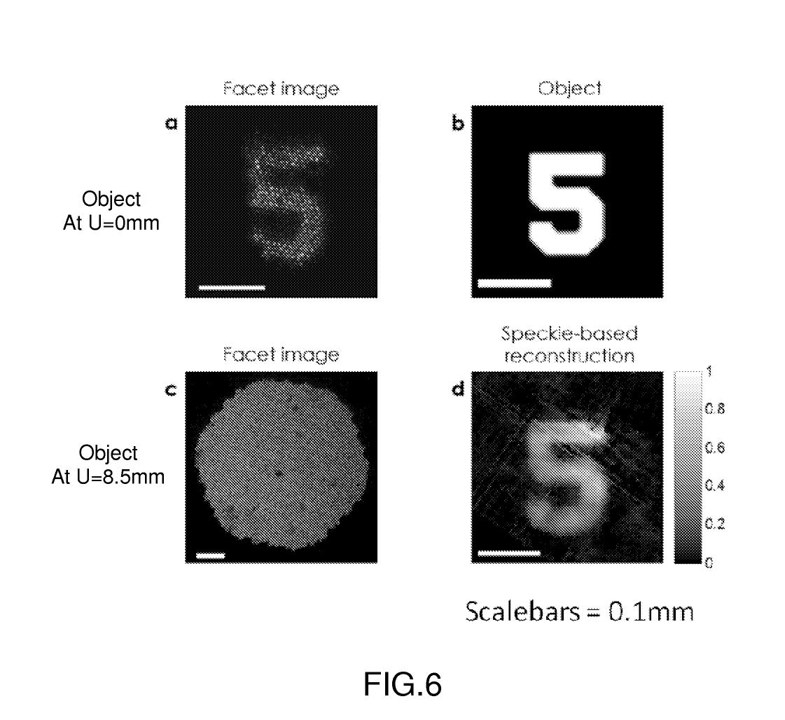

FIG. 6 illustrates an experimental demonstration of the imaging principle described above and implemented using the set-up shown in FIG. 5.

FIG. 6a) shows the conventional imaging (image in the plane of the fiber bundle's proximal facet) through a fiber bundle that requires the object to be placed at U=0 mm. FIG. 6b) shows the original object. FIG. 6(c) shows the conventional imaging through a fiber bundle, when the object is U=8.5 mm away from the bundle's distal facet. As it can been observed, no information is obtainable. FIG. 6(d) shows the speckle image of the object, positioned 8.5 mm away from the bundle's input facet. All scale bars are 100 μm, where in the speckle image the scale bar gives the equivalent scale at the object plane.

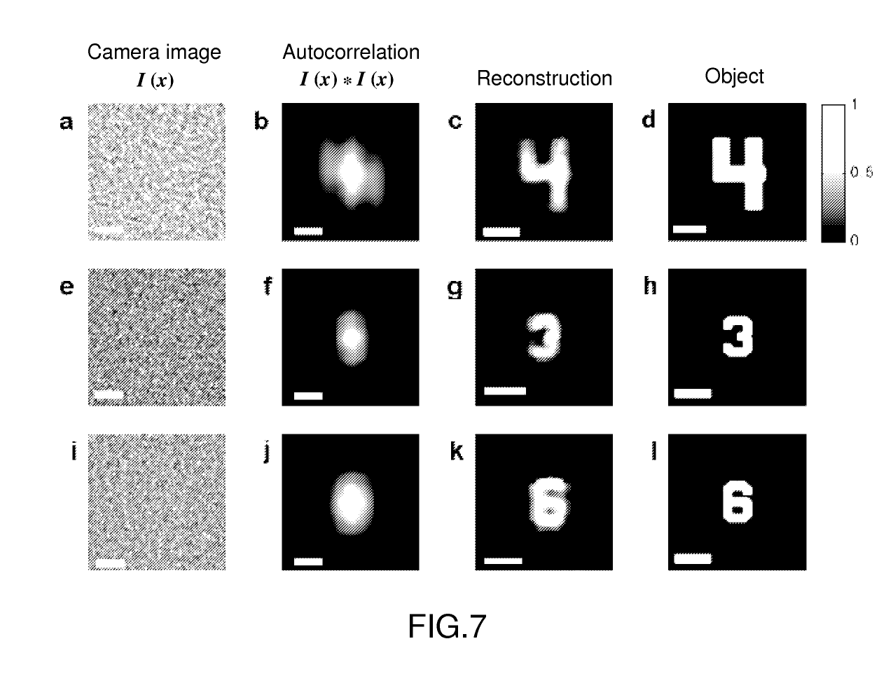

FIG. 7 shows several examples of the different steps in the high resolution imaging method according to the present description and obtained using the set-up of FIG. 5 with 3 different objects of 1951 USAF target “4”, “3” and “6” represented in FIG. 7d, 7h, 7l, respectively. FIGS. 7d) and 7h) show objects from USAF chart group 0 (that were positioned at U=161 mm from the bundle's distal facet, and FIG. 7l) shows an object from USAF chart group 1 that was positioned at U=65 mm from the bundle's distal facet. The Scale bars in the images shown in FIG. 7 are 2600 μm for FIGS. 7a), 7e), 7i); 130 μm for FIGS. 7b), 7c), 7f), 7g), 7j), 7k); 500 μm for FIGS. 7d), 7h); 250 μm for FIG. 7l).

FIGS. 7a), 7e), 7i) show the raw camera images obtained by single-shot imaging of the different objects. FIGS. 7b), 7f), 7j) show the autocorrelation of the camera image for the different objects, and FIGS. 7c), 7g), 7k) show the object reconstruction from the calculated autocorrelation, next to the original objects 7d), 7h), 7l respectively.

Experimental results presented in FIG. 7 show the feasibility of the novel high resolution imaging method according to the present description, which may be performed with a single-shot at an arbitrary imaging plane, and uses essentially the same setup already used in fiber bundle endoscopes.

Some parameters of the imaging method according to the present description are now described.

Field of View (FOV)

The FOV is limited by the optical system's angular correlation width δθ_{awe} as described by equation (1). In a fiber bundle, this width is given by the core's numerical aperture (NA) and the FOV can be described by the equation below:

$$F O V = δ {θ}_{awc} = NA = \frac{λ}{{d}_{mode}} \qquad ( 4 )$$

For single-mode cores with no core-to-core coupling, the FOV will thus be given by the diameter d_{mode} of the mode, substantially equal to the core diameter d_{core}. However, in practical cases when the cores of the optical fibers forming the bundle are not completely decoupled or the cores no purely single-mode, the diameter d_{mode} of the mode may be larger than the diameter of the core itself and the FOV will be reduced.

In practice, the actual core's numerical aperture (NA) may be known from the commercial specifications of the fiber bundle or determined experimentally for a given fiber bundle.

Applicants have shown experimentally that a field of view as large as a few millimeters may be obtained for objects located at a distance U of 1 cm or more from the bundle distal facet.

Minimal Distance U_{crit} Between the Fiber Bundle's Distal Facet and the Object

As previously shown, systems and methods of the present description exploit the correlations of the speckle patterns to image objects placed at any arbitrary distance from the bundle distal end.

However, in the high resolution imaging method according to the present description, the signal to noise ratio will be optimized when the object is placed at a minimal distance U_{crit} from the fiber bundle's distal facet to ensure that each point in the FOV is coupling light to a sufficient number of fiber bundle's cores, defined as the “transmission cores, and thus creates the same speckle pattern on the far side.

The minimal distance U_{crit} is thus related both to the effective diameter of the bundle, and the core's numerical aperture (NA):

$${U}_{crit} = \frac{{D}_{bundle}}{NA} = \frac{{D}_{bundle} \cdot {d}_{mode}}{λ} \qquad ( 5 )$$

where λ is the central wavelength, d_{mode} is the mode field diameter in the inner bundle cores, and NA is a single core's numerical aperture.

The effective diameter of the bundle is equal to the diameter of the bundle itself when the transmission cores comprise all the cores of the bundle.

Resolution

The resolution of the imaging method according to the present description is limited by the diffraction limited speckle grain dimensions, which is determined by the geometrical and numerical apertures (NA) properties of the fiber bundle, as one cannot distinguish between features of the object which are separated by less than the speckle grain size.

This diffraction limited resolution can also be derived from the Fourier transform of Eq.3 above, using the Wiener-Khinchin theorem:

|Ĩ(k)|²=|Õ(k)|²·|P\tilde{S}F(k)|² (6)

As |P\tilde{S}F(k)|² is a window of the size of the fiber bundle's aperture, the object's Fourier spectrum is filtered to the diffraction limited resolution.

The speckle grain size δx (and the resolution) follows approximately the formula:

$$\partial x = \sqrt{{( \frac{λ}{{D}_{bundle}} \cdot U )}^{2} + {d}_{mode}^{2}} \qquad ( 7 )$$

Which is derived from the diffraction from the cores, where λ is the wavelength, D_{bundle} is the fiber bundle's diameter and d_{mode} is a single core mode field diameter.

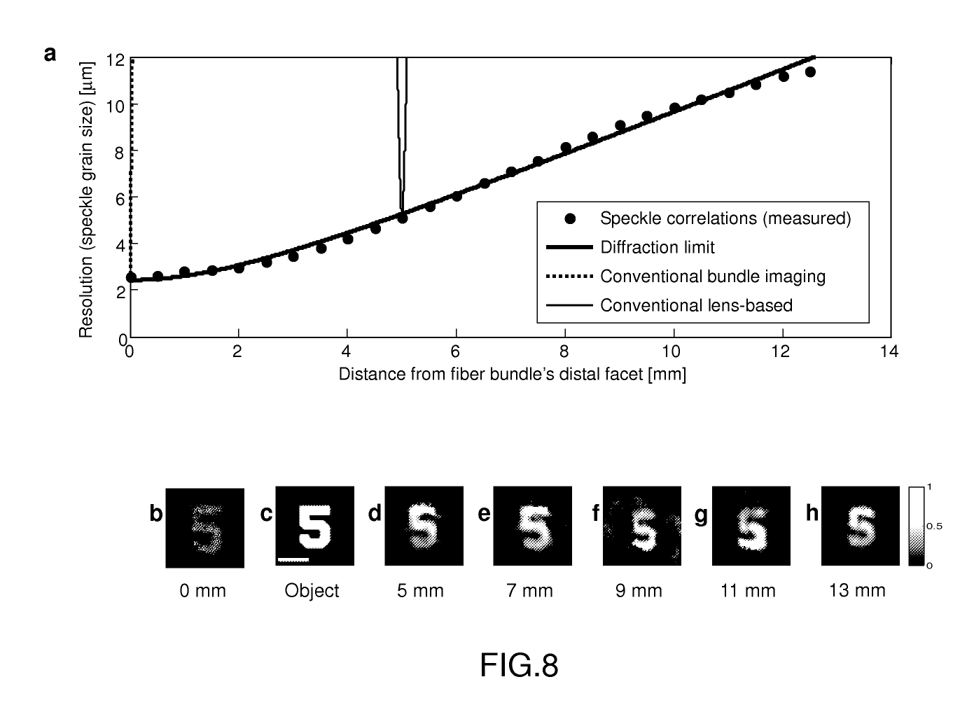

FIG. 8a) presents an experimental characterization of the resolution given by the speckle grain size as a function of the distance from the object to the fiber bundle's facet (U), side-by-side with a comparison to the resolution of conventional bundle based imaging technique (dotted line) and to the resolution of conventional lens-based imaging technique (continuous thin line). The experimental set-up is the same as the one shown in FIG. 5. More specifically, FIG. 8a shows the measured resolution (diffraction limited speckle grain size) as a function of the distance (U) from the fiber bundle's distal facet. The measured speckle grain size is fitted to the diffraction limit as described in Eq (7), using D_{bundle} and d_{mode} as variables, whose final values are in good agreement with the fiber bundle's specifications.

The minimum distance for high signal to noise ratio single-shot imaging is

$${U}_{crit} = \frac{{D}_{bundle} \cdot {d}_{mode}}{λ}$$

i.e., the minimal distance at which each point in the speckle field (FOV) is coupling light to all the transmission bundle's cores defining the effective diameter of the bundle.

In the example of FIG. 8a, U_{crit} is calculated as equal to about 3 mm.

On top of the graph appears estimations for other conventional methods resolutions (the conventional lens-based assumes a relay lens that images the fiber distal facet at U=5 mm).

FIG. 8b) shows a conventional image through a fiber bundle of an object from the 1951 USAF target, USAF chart group 3, Scale bar=100 μm and shown in FIG. 8c).

FIGS. 8d) to 8h) are images taken with the experimental set-up described in FIG. 5 using different distances of the object to the fiber bundle's distal facet.

The diffraction limited resolution that is attained at any distance from the fiber provides a very large range of working distances, as it is demonstrated by imaging a digit from the USAF target at various distances (FIGS. 8d) to 8h)).

Number of Speckle Patterns Used

Another parameter of the imaging method according to the present description is the number of speckle patterns used, which number is limited by the effective number of the transmission cores in the fiber bundle. For a low coupling, the effective number of transmission cores may be the actual number of transmission cores, which may be, in some embodiments, the actual number of cores in the fiber bundle. However, coupling between the cores may lower the actual number of independent cores.

A low number of speckles can lead to insufficient ensemble averaging that in turn hinders the signal to noise ratio (SNR) in the intensity image's autocorrelation.

Besides lowering the imaging resolution, this can affect the imaging of large objects whose size is comparable to the bundle's NA, as the center of the object will have more speckle patterns averaging than its edges.

In single-shot imaging, the applicants have shown that it is advantageous to have more than 100 transmission cores, advantageously more than transmission 500 cores, advantageously more than transmission 2000 cores.

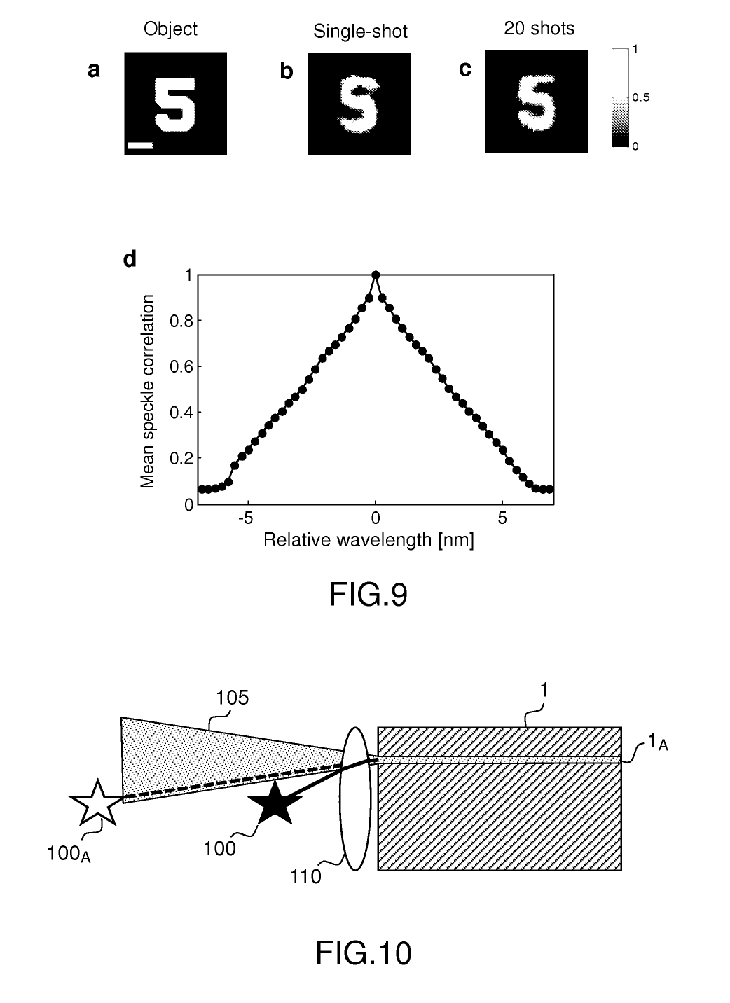

However, according to one or more embodiments, a multiple shot instead of a single-shot technique may be used, by averaging over the autocorrelation of more than one multiple speckles image, as illustrated in FIG. 9 below.

According to one or more embodiments, getting more than one multiple speckles image may be achieved in different ways. For example, the number of different uncorrelated speckle patterns may be increased by simply changing the bundle physical placement and bending, by using different orthognal polarization states of the light illuminating the object, by changing the wavelength of the light illuminating the object or the light detected by the two dimensional detector, and more.

Spectral Bandwidth of the Source

To consider the applicability of the approach to broadband illumination or fluorescence imaging, the experiments of FIG. 7 were repeated with a broadband illumination light source.

The experimental set-up is essentially similar as the one shown in FIG. 5. The light source is based on a Spectra-physics® Mai Tai broadband laser, with a spectral width of 10 nm centered around 800 nm, and no focusing lens 503 is used. The fiber bundle used for broadband images is 48.5 cm long, with a diameter of 1.1 mm and about 18 000 cores with 8 μm inter-core distance.

The applicants have shown that broadband illumination can be used, without appreciably affecting the performance of the method, as long as the illumination bandwidth is narrower than the fiber bundle's speckle spectral correlation bandwidth. Within this bandwidth, the wavelength-dependent speckle pattern produced by the bundle stays well correlated, and it is related by Fourier transform to the time delay spread of the light propagating in the different cores.

To demonstrate this, and as a step towards fluorescence imaging, the fiber bundle's spectral correlation width is measured and demonstrated imaging using a broadband source, as presented in FIG. 9.

More specifically, FIG. 9a) shows the original object pattern (Scale bar is 100 μm). FIG. 9b) shows a single-shot broadband speckle image and FIG. 9c) shows a 20 shot broadband speckle image.

In FIG. 9c), each shot is taken with a different uncorrelated speckle pattern, produced by changing the bundle's physical shape. The additional shots were taken in order to improve the autocorrelation's signal-to-noise ratio, as previously discussed.

FIG. 9d) shows experimentally measured spectral correlations of a fiber bundle as a function of the relative wavelength defined in relation with a “central wavelength” (referred as “O” in FIG. 9d). Each measurement point corresponds to the autocorrelation between the speckle obtained at the central wavelength and the speckle obtained at the relative wavelength.

As it can be seen from FIG. 9 the bandwidth of light illuminating the object can be extended up until the spectral correlation width, which is around 8 nm (FWHM) in this example. It is thus possible to use very short pulses in the imaging method according to the present description, as short pulses, e.g. 150 fs pulses typically have a spectral bandwidth of 10 nm.

Alternatively, a broadband source may be used and filtering achieved at the detection side.

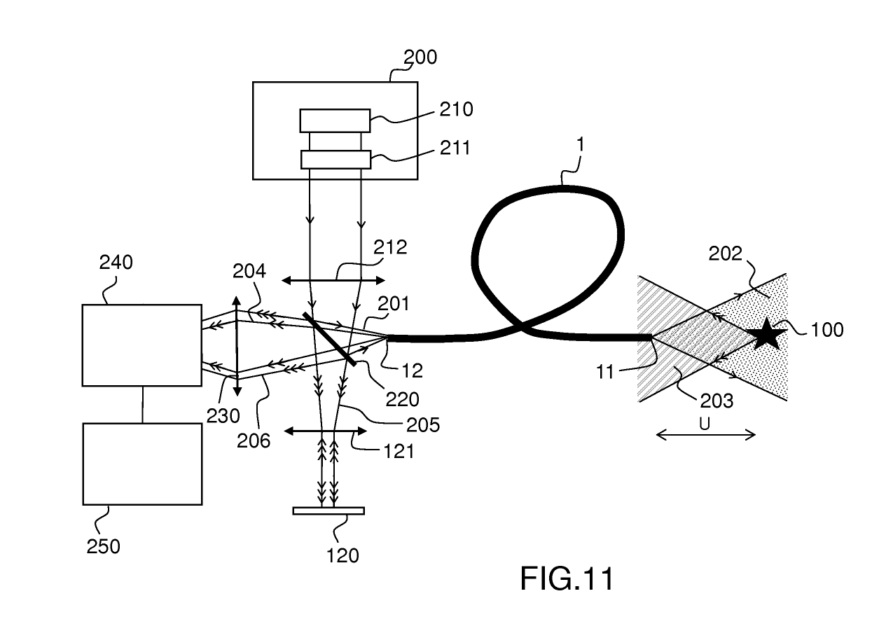

FIG. 10 and FIG. 11 illustrate two embodiments of a high resolution imaging system according to the present description.

In one or more embodiments, as shown in FIG. 10, the high resolution system according to the present description may further comprise a lens 110 at the distal end of the fiber bundle to shorten the critical distance U_{crit} at which an object may be imaged. The lens 110 generates a virtual image 100_{A} of the object 100, wherein said virtual image 100_{A} of the object 100 is located at a further distance than the real object 100.

FIG. 11 illustrates a schematic illustration of another embodiment of a device according to the present description adapted to implement an embodiment of a high resolution imaging method according to the present description in which the distance U of the object from the fiber bundle's distal facet may be determined.

All elements are essentially similar to the elements shown in FIG. 2 and the same processing steps of the imaging methods may be applied.

In this embodiment, the light 201 emitted by the source 200 is spatially incoherent, and present a narrow spectral bandwidth, i.e. a spectral bandwidth smaller or equal than the spectral correlation width of the bundle (see FIG. 9d). The light 203 transmitted for example through a part of the cores of the bundle 1 illuminates the object and is reflected by the object 100, thus being temporally coherent with the emitted light 201.

To determine the distance U at which the object is located from the fiber bundle's distal facet, the light 201 emitted by the source 200 is split into a reference arm (of length d), for example using the beam splitter 220, thereby forming the light 205. The light 205 is then remixed on the detector 240 with the light 204 reflected from the sample and transmitted through the transmission cores of the fiber bundle 1. The reference arm comprises for example a mirror 120 whose axial position can be modified to change the length d.

If L is the fiber length, and U the object distance between the fiber distal facet and the objet, matching d=L+U generates fringes on the camera plane.

It is therefore possible to determine d, and consequently to determine the distance U at which the object 100 is located from the fiber bundle's distal facet.

We have presented robust, simple and calibration-free high resolution imaging systems and methods. Compared to other new endoscopic techniques (Multimode fiber transmission matrix approach, digital phase conjugation approach and others), the high resolution imaging methods according to the present description are insensitive to fiber movements, works inherently with spatially incoherent illumination in a single-shot, whereas most other transmission matrix techniques required coherent illumination, and perform incoherent imaging by scanning a focused coherent spot.

Although described by way of a number of detailed example embodiments, the system and method for high resolution imaging according to the present description comprise various variants, modifications and improvements that will be obvious to those skilled in the art, it being understood that these various variants, modifications and improvements fall within the scope of the invention such as defined by the following claims.

1. A system for high resolution imaging of an object comprising:
a fiber bundle comprising an array of optical fiber cores, said fiber bundle being adapted to receive a plurality of light beams issued from spatially incoherent point sources of an object;
a two-dimensional detector having a detection plane, located at a proximal end of the fiber bundle, adapted to receive speckle patterns, each speckle pattern resulting from the transmission of one of said light beams through at least a plurality of the fiber bundle cores, the ensemble of speckle patterns detected by the two-dimensional detector forming a multiple speckles image; and
a processing unit adapted to determine an image of the object from said multiple speckles image.

2. The system according to claim 1, wherein the processing unit is adapted to perform:
an autocorrelation product of the multiple speckles image;
a determination of the image of the object based on the autocorrelation product of the multiple speckles image.

3. The system according to claim 1, further comprising a light source adapted to illuminate the object.

4. The system according to claim 1, further comprising a lens at the distal end of the fiber bundle to shorten a minimal distance at which an object may be imaged with an optimized signal to noiseratio.

5. The system according to claim 1, further comprising:
a reference arm of variable length;
a beam splitter to split a spatially incoherent light emitted by a source into a light for illuminating the object and a light to be sent into the reference arm; and
a beam splitter to mix the light from the reference arm and the light back reflected from the object and transmitted by the at least part of the cores of the fiber bundle at the detection plane.

6. A method for high resolution imaging of an object comprising:
receiving at the distal end of a fiber bundle comprising an array of optical fiber cores a plurality of light beams issued from spatially incoherent point sources of an object;
receiving on a detection plane of a two-dimensional detector located at a proximal end of the fiber bundle, a plurality of speckle patterns, each speckle pattern resulting from the transmission of one of said light beams through at least a plurality of the fiber bundle cores, the ensemble of speckle patterns detected by the two-dimensional detector forming a multiple speckles image; and
processing said multiple speckles image to determine an image of the object.

7. A method according to claim 6, wherein processing the multiple speckles image comprises:
calculating an autocorrelation product of the multiple speckles image; and
determining the image of the object based on the autocorrelation product of the multiple speckles image.

8. The method according to claim 6, further comprising illuminating the object using a light emitted by a light source.

9. The method according to claim 8, wherein illuminating the object is made through at least part of the optical fiber cores of the fiber bundle.

10. The method according to claim 8, wherein the object is illuminated in transmission or in reflection, using a spatially incoherent light.

11. The method according to claim 8, wherein the object emits light at a different wavelength that the wavelength of the source to form said plurality of light beams.

12. The method according to claim 6, further comprising randomly moving the fiber bundle at the proximal end to increase the number of speckle patterns.

13. The method according to claim 6, further comprising randomly changing the wavelength of a light illuminating the object to increase the number of speckle patterns.

14. The method according to claim 6, further comprising randomly changing the polarization state of a light illuminating the object to increase the number of speckle patterns.

15. The method according to claim 6, further comprising determining the distance between the object and the fiber bundle's distal facet by:
splitting a spatially incoherent light into a light for illuminating the object and a light to be sent in a reference arm of a variable length;
mixing at the detector plane the light from the reference arm and the light back reflected from the object and transmitted by the at least part of the cores; and
changing the length of the reference arm to generate interference fringes at the detector plane.

16. The system according to claim 2, further comprising a light source adapted to illuminate the object.

17. The system according to claim 2, further comprising a lens at the distal end of the fiber bundle to shorten a minimal distance at which an object may be imaged with an optimized signal to noise ratio.

18. The system according to claim 2, further comprising:
a reference arm of variable length;
a beam splitter to split a spatially incoherent light emitted by a source into a light for illuminating the object and a light to be sent into the reference arm; and
a beam splitter to mix the light from the reference arm and the light back reflected from the object and transmitted by the at least part of the cores of the fiber bundle at the detection plane.

19. The method according to claim 7, further comprising illuminating the object using a light emitted by a light source.

20. The method according to claim 9, wherein the object emits light at a different wavelength that the wavelength of the source to form said plurality of light beams.
